(19) United States
(12) Patent Application Publication
(10) Pub. No.: US 2025/0299508 A1
(43) Pub. Date: Sep. 25, 2025

(54) Device and Method for Multimodal Video Analysis

(71) Applicant: Huawei Technologies Co., Ltd., Shenzhen (CN)

(72) Inventors: Yang Sun, Shenzhen (CN); Marco Godi, Amsterdam (NL); Federico Landi, Amsterdam (NL)

(21) Appl. No.: 19/231,770

(22) Filed: Jun. 9, 2025

Related U.S. Application Data
(63) Continuation of application No. PCT/EP2022/085200, filed on Dec. 9, 2022.

(51) Int. Cl. G06V 20/70; G06F 16/48

(52) U.S. Cl. CPC G06V 20/70; G06F 16/489

(57) ABSTRACT

A device is configured to receive a video stream. The device is further configured to determine video-level tags and time-stamped tags, based on at least two frames of the video stream, audio information of the video stream and an inference technique.

### CROSS-REFERENCE TO RELATED APPLICATIONS

This is a continuation of International Patent Application No. PCT/EP2022/085200 filed on Dec. 9, 2022. The disclosures of the aforementioned applications are hereby incorporated by reference in their entireties.

### TECHNICAL FIELD

The present disclosure relates to the field of video analysis, in particular for tagging a video based on an inference technique. The present disclosure therefore provides a device for multimodal video analysis to extract tags based on several attributes of the video. Moreover, a corresponding method and computer program are provided.

### BACKGROUND

Short-video platforms are getting more and more popular. People, especially young generations, use short videos as a main source of information and learn about their topics of interest by watching short videos, instead of reading text. Videos online are usually equipped with a list of tags (e.g., a soccer video could be paired with “soccer”, “Germany”, “Italy”, “World Championship”, etc.) that synthesize their content and act as “containers” that group together similar videos. However, such containers only work inside a website and are tailored to facilitate the retrieval of similar video content in that same platform.

Usually, when browsing the internet, it is common to start from a page and navigate from there, link by link, until one gets to precisely what is needed. However, it is not convenient to initiate a search from a video which has been watched. This is, because video tags defined by an uploader usually do not cover all or most aspects and topics users may want to search for, and because video searches have a close-loop in the short-video platform. That is, there is no easy way to search in another search engine with a simple click.

To address and alleviate this, existing work makes use of machine learning to understand the content of the video and produce a list of relevant tags automatically. Nonetheless, the tagging system is mainly used for indexing purposes and to suggest other videos that can be searched for, rather than initiate a search starting directly from the video content. For this kind of interactions there is currently a lack of solutions that can achieve the desired level of simplicity.

In fact, if a user wants to search for some topic related to the content of the video (e.g., using an external and better suited search engine), there are two possibilities: if the tag is already paired with the video, users can search for it manually by copying and pasting the content of the tag into the relevant webpage. This process is time consuming and requires unreasonable manual effort from the user. This is especially true as user behaviors are leaning towards faster and simpler interactions with the contents of the web, and the desired information should always be only one click away. If a video is not tagged with the topic of interest desired by the user, the situation gets even worse, as users need to open a search engine and formulate a correct search query by typing it manually.

Some solutions focus on the retrieval of related content from video sources, which can be used for tagging the video. This is often done by using machine learning and red-green-blue (RGB) frames (i.e., a single image that composes a video). Some solutions include identifying objects in a scene and displaying interactive content overlaid with the video content upon user request; enriching video content by retrieving additional video sources that can be displayed alongside the main video; or identifying persons of interests, such as actors, and displaying pop-up tags at different moments during the video.

Although the solutions may seem to cover a wide set of use cases, a recent change in video content brought mainly by social media platforms creates new challenges and problems that are left unsolved: The focus of the video is no more on a specific person/object, but rather an action (e.g., a trendy dance or an athletic performance). Moreover, the information payload of recent videos may not only reside in images.

As a result, the solutions cannot analyze complex actions nor provide corresponding tags in recent videos.

### SUMMARY

In view of the above-mentioned problem, an objective of embodiments of the present disclosure is to provide a way for tagging a video based on a multimodal video analysis.

This or other objectives may be achieved by embodiments of the present disclosure as described in the enclosed independent claims. Advantageous implementations of embodiments of the present disclosure are further defined in the dependent claims.

A first aspect of the present disclosure provides a device for multimodal video analysis, wherein the device is configured to receive a video stream, and determine video-level tags and time-stamped tags, based on at least two frames of the video stream, audio information of the video stream and an inference technique.

This ensures that complex actions in a video stream can by analyzed and tags can be determined, accordingly.

In particular, a tag refers to a specific situation in the video stream. In particular, a tag refers to a single data modality or multiple data modalities (e.g., a data modality comprises an appearance of a specific object or text in a video, or an appearance of sound or speech in the video).

In an implementation form of the first aspect, the video stream comprises metadata, and the device is further configured to determine the video-level tags and the time-stamped tags based on the metadata.

This ensures that various source of information in the video can be combined for analysis and tagging.

In particular, the metadata comprises at least one of: a title of the video stream, a duration of the video stream, a textual description, e.g. inserted by a user or by a website, a comment, a number of likes and/or views, geographical information regarding the upload of the video stream. In other words, the metadata of the video stream comprises any source of information other than the audio information and the video stream.

In particular, the metadata can be processed using natural language processing (NLP) techniques when the data is textual, and/or general machine learning techniques when it comprises structured data (e.g., a Global Positioning System (GPS) location or a number).

In a further implementation form of the first aspect, the inference technique comprises at least one of: automatic speech recognition, ASR; optical character recognition, OCR; computer vision, CV; natural language processing, NLP.

This is beneficial, as several ways of determining tags can be employed.

In a further implementation form of the first aspect, the device is further configured to store the video-level tags and the time-stamped tags in a tag database of the device.

This is beneficial, as the tags only need to be generated once and can be loaded when they are needed.

In particular, the tag database comprises a database that stores, for each video stream, tags associated with the video stream (either video-level tags or time-stamped tags with associated time ranges).

In a further implementation form of the first aspect, the device is further configured to provide the video-level tags to a user device playing the video stream.

This is beneficial, as the tags obtained by the device can be used on a user device, e.g., a mobile phone, a tablet, a laptop, or a desktop computer.

In a further implementation form of the first aspect, the device is further configured to receive a user input comprising playback time information from a user device playing the video stream, and provide the time-stamped tags to the user device, based on the playback time information.

This ensures that only those time-stamped tags are provided to the user device, which correspond to the playback time (that is, the point in time of the video which is presently shown) of the video play on the user device.

In a further implementation form of the first aspect, the device is further configured to determine video-level recommendations based on the video-level tags and a resource index stored in the device; and/or determine time-stamped recommendations based on the time-stamped tags and the resource index.

This ensures that based on the tags, also recommendations which are relevant for a user can be displayed.

In particular, the resource index comprises a database of recommended resources (e.g., an index of videos or a list of ads, e.g., with metadata for recommendation pairing).

In particular, a video-level recommendation and/or a time-stamped recommendation comprises at least one of: a uniform resource locator (URL) (e.g., to initiate a search), a related video, a related search query, a map location, a shopping item.

In a further implementation form of the first aspect, the device is further configured to store the video-level recommendations and the time-stamped recommendations in a recommendation database of the device.

This ensures that the recommendations only need to be generated once and can be loaded from the database when they are needed.

In particular, the recommendation database comprises a database that stores, for every video stream, recommended resources (such as related videos or suggested ads).

In a further implementation form of the first aspect, the device is further configured to provide the video-level recommendations to a user device playing the video stream.

This ensures that only relevant recommendations are provided to the user device.

In a further implementation form of the first aspect, the device is further configured to provide the time-stamped recommendations to the user device, based on the playback time information, in response to receiving the user input.

This ensures that the specific point in time of the video which is presently shown is taken into consideration, when providing recommendations to the user device.

In a further implementation form of the first aspect, the device is further configured to receive a request from a user device playing the video stream, and receive the video stream, determine the video-level tags and the time-stamped tags, and directly provide the video-level tags and the time-stamped tags to the user device, based on the request.

This ensures that the video stream can be analyzed upon request.

In a further implementation form of the first aspect, the video-level tags comprise information that refers to the video stream as a whole.

This is beneficial, as this kind of tag may indicate relevant information about the whole video stream

In particular, the video-level tag covers the content of the whole video stream.

In a further implementation form of the first aspect, the time-stamped tags comprise information that refers to a specific time range of the video stream.

This is beneficial, as this kind of tag may indicate information which is relevant at a specific point in time of the video stream.

In particular, the time-stamped tag relates to a topic that occurs only in an interval of the video. In particular, time-stamped information is composed of three elements: 1) begin time, 2) end time, and 3) tag content related to the information that can be found between the begin time and the end time.

A second aspect of the present disclosure provides a method for multimodal video analysis, wherein the method comprises the steps of receiving, by a device, a video stream; and determining, by the device, video-level tags and time-stamped tags, based on at least two frames of the video stream, audio information of the video stream and an inference technique.

In an implementation form of the second aspect, the video stream comprises metadata, and the method comprises determining, by the device, the video-level tags and the time-stamped tags based on the metadata.

In a further implementation form of the second aspect, the inference technique comprises at least one of: automatic speech recognition, ASR; optical character recognition, OCR; computer vision, CV; natural language processing, NLP.

In a further implementation form of the second aspect, the method further comprises storing, by the device, the video-level tags and the time-stamped tags in a tag database of the device.

In a further implementation form of the second aspect, the method further comprises providing, by the device, the video-level tags to a user device playing the video stream.

In a further implementation form of the second aspect, the method further comprises receiving, by the device, a user input comprising playback time information from a user device playing the video stream, and providing, by the device, the time-stamped tags to the user device, based on the playback time information.

In a further implementation form of the second aspect, the method further comprises determining, by the device, video-level recommendations based on the video-level tags and a resource index stored in the device; and/or determining, by the device, time-stamped recommendations based on the time-stamped tags and the resource index.

In a further implementation form of the second aspect, the method further comprises storing, by the device, the video-level recommendations and the time-stamped recommendations in a recommendation database of the device.

In a further implementation form of the second aspect, the method further comprises providing, by the device, the video-level recommendations to a user device playing the video stream.

In a further implementation form of the second aspect, the method further comprises providing, by the device, the time-stamped recommendations to the user device, based on the playback time information, in response to receiving the user input.

In a further implementation form of the second aspect, the method further comprises receiving, by the device, a request from a user device playing the video stream, and receiving, by the device, the video stream, determining, by the device, the video-level tags and the time-stamped tags, and directly providing, by the device, the video-level tags and the time-stamped tags to the user device, based on the request.

In a further implementation form of the second aspect, the video-level tags comprise information that refers to the video stream as a whole.

In a further implementation form of the second aspect, the time-stamped tags comprise information that refers to a specific time range of the video stream.

The second aspect and its implementation forms include the same advantages as the first aspect and its respective implementation forms.

A third aspect of the present disclosure provides a computer program comprising instructions which, when the program is executed by a computer, cause the computer to perform the method according to the second aspects or any of its implementation forms.

The third aspect includes the same advantages as the first aspect and its respective implementation forms.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms of the present disclosure will be explained in the following description of specific embodiments in relation to the enclosed drawings, in which

FIG. 1 shows a schematic view of a device according to an embodiment of the present disclosure;

FIG. 2 shows a schematic view of a device according to an embodiment of the present disclosure in more detail;

FIG. 3 shows another schematic view of a device according to an embodiment of the present disclosure;

FIG. 4 shows a detailed schematic view of creating tags based on an inference technique according to the present disclosure;

FIG. 5 shows a detailed schematic view of creating recommendations based on a resource index according to the present disclosure;

FIG. 6 shows a schematic view of an operating scenario according to an embodiment of the present disclosure;

FIG. 7 shows a detailed schematic view of displaying tags and recommendations according to the present disclosure;

FIG. 8 shows a schematic view of an operating scenario involving a server and a user device according to an embodiment of the present disclosure;

FIG. 9 shows another schematic view of an operating scenario involving a server and a user device according to an embodiment of the present disclosure;

FIG. 10 shows another schematic view of displaying tags and recommendations according to the present disclosure;

FIG. 11 shows yet another schematic view of displaying tags and recommendations according to the present disclosure;

FIG. 12 shows a schematic view of a method according to an embodiment of the present disclosure.

### DETAILED DESCRIPTION OF EMBODIMENTS

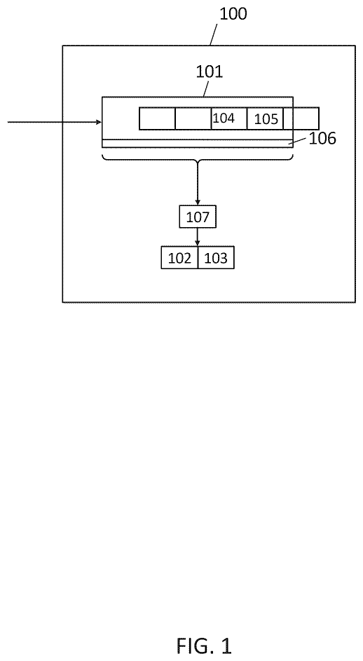

FIG. 1 shows a schematic view of a device 100. The device 100 is for multimodal video analysis. To this end, the device 100 is configured to receive a video stream 101. The device 100 is further configured to determine video-level tags 102 and time-stamped tags 103, based on at least two frames 104, 105 of the video stream 101, audio information 106 of the video stream 101 and an inference technique 107.

The device 100 thereby contributes to user navigation starting from a video using multimodal information. For this purpose, the device 100 combines multimodal video understanding and analysis and a video-based interactive search method.

The device 100 facilitates predicting tags for a given video (i.e., the video stream 101). These tags can either refer to the video as a whole (i.e., the video-level tags 102) or to a specific time-range (i.e., the time-stamped tags 103). In other words, tags associated with a specific time-range can be time-stamped.

In particular, a video-level tag 102 can be regarded as a tag (e.g., a word) that represents information about the content of the video stream 101 as a whole. In particular, a time-stamped tag 103 can be regarded as a tag (e.g., a word) that represents information about a part (e.g., a segment or an interval) of the video stream 101.

For example, for a vlog (i.e., a video blog) video stream 101 of a user, the video-level tags 102 can be just “vlog” or “a day at school”. In this case, the time-stamped tags can be “math class”, which happened e.g., in the morning, that is, in the first half of the video, or “sports class” which happens after the math class, that is, in the second half of the video.

The tags 102, 103 can be inferred using a multimodal approach, which means that all of the information channels in the video stream 101 can be used, such as the image frames 104, 105 that compose the video stream 101, the audio information 106 being played, the speech which could be present, text metadata paired with the video, etc.

In particular, the audio information 106 comprises audio information of the video stream 101. That is, the audio information 106 can be regarded as the audio stream of the video stream 101. The audio information 106 e.g., can comprise at least one of: sound, speech, music, noise.

The tags 102, 103 can either refer to one specific data modality (e.g. for video tagging the appearance of a specific object, for speech tagging a topic that is discussed) or multiple modalities combined (e.g. tagging a specific dance based on the movements and the music of the dance). In those cases, information fusion can be performed.

The video-level tags 102 may comprise information that refers to the video stream 102 as a whole. The time-stamped tags 103 may comprise information that refers to a specific time range of the video stream 102.

The output of the device 100 can be regarded a list of tags 102, 103 (relative to the video as a whole or only to a part of it) that describe the content of the video and are determined by taking into consideration one or more channels of information in the video stream 101.

Thereby, the device 100 also contributes to an interface that enables a simple and fast search starting from a video stream 101 being watched. While watching a video stream 101, a user can press a button at any moment to make an interface pop up. The interface may contain a set of tags 102, 103 and additional recommended content (such as video recommendations or ads) based on those tags. The tags being shown may correspond to a most recently viewed part of the video stream 101. In other words, based on the moment in which the button is pressed, the interface will change by making use of the timestamped tags 103. The intuition is that users will press the button as soon as they see something in the video stream 101 which they want to learn more about, making a list of tags 102, 103 appear which could include a target. The user can then click to search it in a search engine of choice or check the recommended content suggestions.

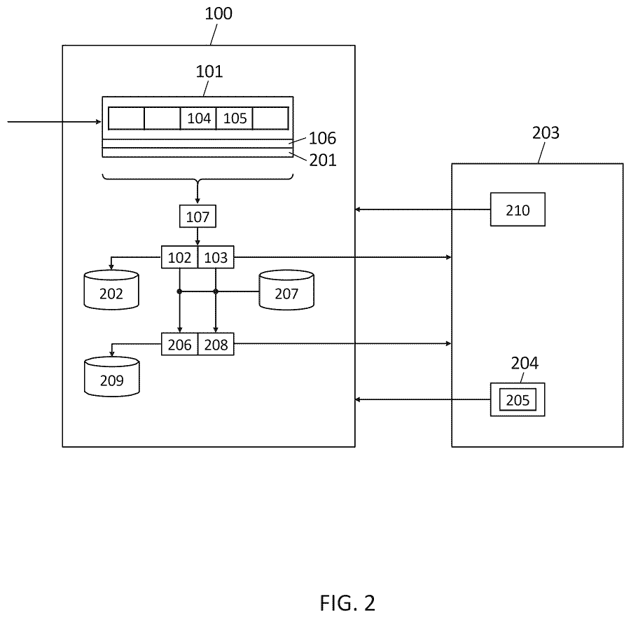

The device 100 is now going to be described in more detail in view of FIG. 2. The device 100 of FIG. 2 includes all functions and features of the device 100 as described in view of FIG. 1.

As it is illustrated in FIG. 2, the video stream 101 optionally can comprise metadata 201. The device 100 can determine the video-level tags 102 and the time-stamped tags 103 based on the metadata 201. That is, the video-level tags 102 and the time-stamped tags 103 can be determined on more information compared to solely the video and audio information in the stream 101.

As it is further illustrated in FIG. 2, the device 100 optionally can store the video-level tags 102 and the time-stamped tags 103 in a tag database 202 of the device 100. From there, the tags can e.g. be provided to a user device 203, if this should be necessary. That is, the device 100 may provide the video-level tags 102 to a user device 203 playing the video stream 101.

To instruct the device 100 for providing the tags, the device 100 can receive a user input 204 comprising playback time information 205 from a user device 203 playing the video stream 101. Upon receiving the user input 204, the device 100 can provide the time-stamped tags 103 to the user device 203, based on the playback time information 205. In other words, the device 100 can provide those time-stamped tags 103 to the user device 203, which are relevant at the point of time at which the video stream 101 is currently playing on the user device 203.

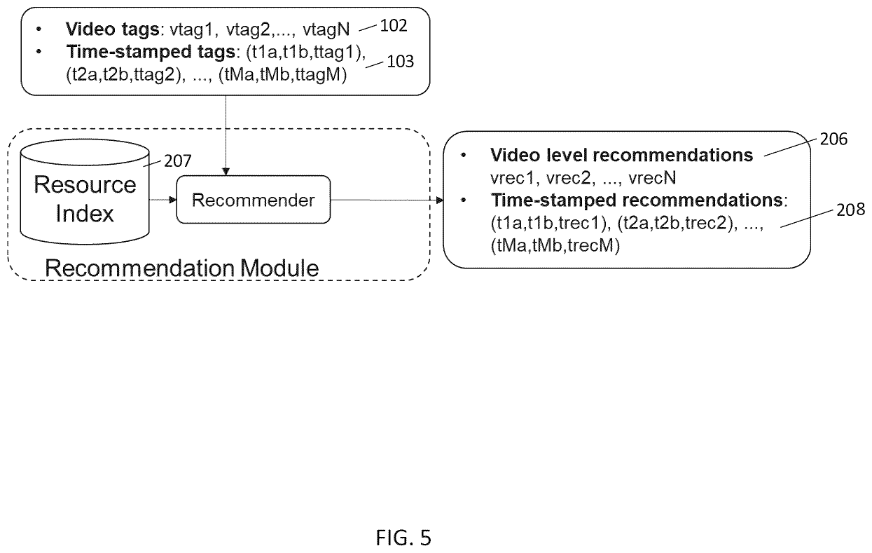

Further optionally, and as it is also shown in FIG. 2, the device 100 can determine video-level recommendations 206 based on the video-level tags 102 and a resource index 207 stored in the device 100. The device 100 additionally, or alternatively can determine time-stamped recommendations 208 based on the time-stamped tags 103 and the resource index 207. This is also illustrated in FIG. 5 in more detail.

Turning back to FIG. 2, the device 100 optionally may store the video-level recommendations 206 and the time-stamped recommendations 208 in a recommendation database 209 of the device 100, similar as it is the case for the tags 102, 103 and the tag database 202. From the database 209, the recommendations can e.g. be provided to the user device 203, if this should be necessary.

That is, the device 100 may provide the video-level recommendations 206 to a user device 203 playing the video stream 101. Additionally, or alternatively, the device 100 may provide the time-stamped recommendations 208 to the user device 203, based on the playback time information 205, in response to receiving the user input 204. That is, the device can provide exactly those time-stamped recommendations 208 to the user device 203, which are relevant for the point of time at which the video stream 101 is shown on the user device 203.

As it is also shown in FIG. 2, the device 100 may receive a request 210 from a user device 203 playing the video stream 101. Triggered by this request, the device may receive the video stream 101, determine the video-level tags 102 and the time-stamped tags 103, and directly provide the video-level tags 102 and the time-stamped tags 103 to the user device 203, based on the request 210. In other words, the device 100 may operate in an online mode, in which the tags 102, 103 are determined for the first time, once the request 210 is received from the user device 203.

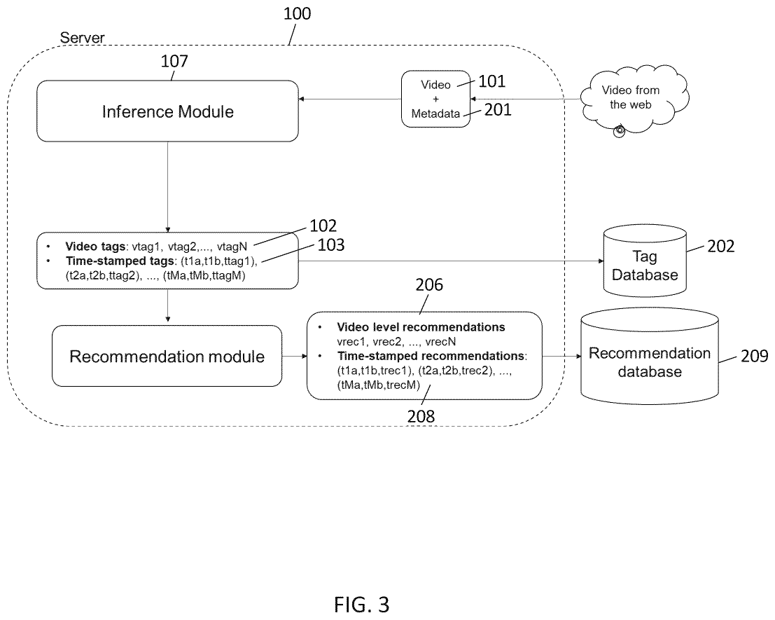

FIG. 3 illustrates an exemplary operating scenario of the device 100, in which the video stream 101 and metadata 201 are received by the device 100 from a network resource, such as the internet. An inference module, which employs the inference technique 107, determines the video-level tags 102 and the time-stamped tags 103, based on at least two frames 104, 105 of the video stream 101, audio information 106 of the video stream 101 and the metadata 201. The video-level tags 102 and the time-stamped tags 103 are then stored in a tag database 202 of the device 100. This is e.g., done in an offline mode of the device 100, in which the device receives video streams 101 from the internet which are not played by a user device 203 at the same time. The device 100 determines the tags 102, 103 in stock, so to speak, and has them ready once a request for providing them is received. The device 100 also provides the video-level tags 102 and the time-stamped tags 103 to a recommendation module, which determines video-level recommendations 206 based on the video-level tags 102 and a resource index 207 stored in the device 100 and additionally or alternatively determines time-stamped recommendations 208 based on the time-stamped tags 103 and the resource index 207.

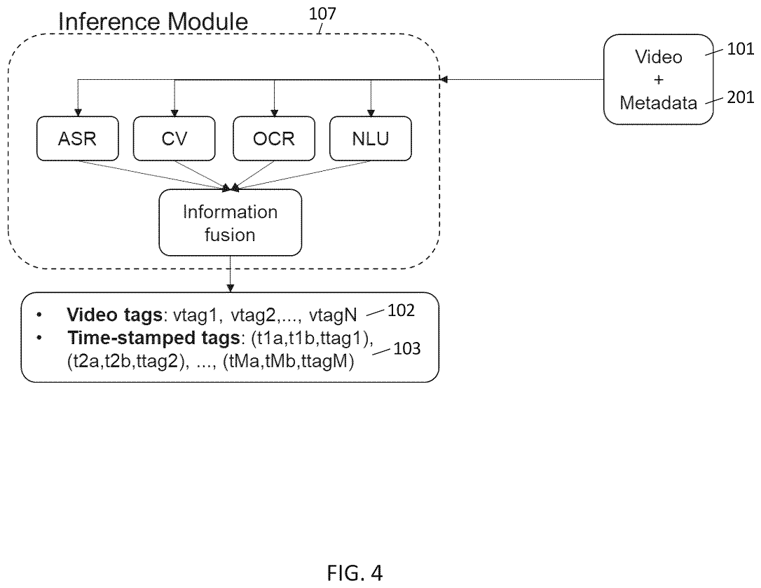

This scenario is illustrated in detail in FIG. 4, which shows several inference techniques 107, such as automatic speech recognition, optical character recognition, computer vision, and natural language processing, NLP. The results from these techniques can be fused for determining the tags 102, 103.

Turning back to FIG. 3, the device 100 then can store the video-level recommendations 206 and the time-stamped recommendations 208 in a recommendation database 209 of the device 100. Once a corresponding request is received by the device 100, the video-level recommendations 206 and the time-stamped recommendations 208 can be provided to a user device 203.

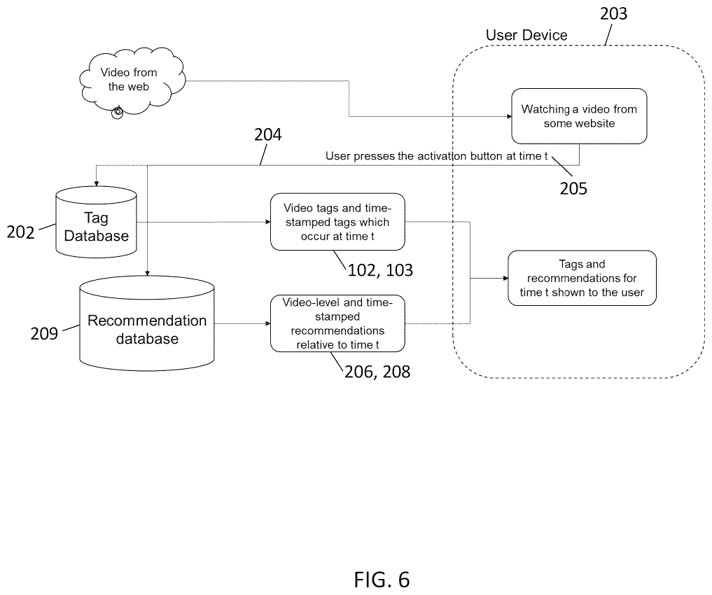

FIG. 6 illustrates another operating scenario of the device 100, in which the user device 203 is playing a video stream 101 which it received from a network resource.

At a specific point of time t, a user of the user device 203 presses a button on the user device 203 and thereby provides a user input 204 comprising playback time information 205 to the device 100. The playback time information 205 comprises the specific point of time at which the video stream 101 is presently playing at the user device 203.

Once the user input 204 comprising the playback time information 205 is received from the user device 203 the time-stamped tags 103 are provided to the user device 203, based on the playback time information 205. Additionally or alternatively, the video-level tags 102 are provided as well.

In response to receiving the user input 204, also the time-stamped recommendations 208 can be provided to the user device 203, based on the playback time information 205. Additionally or alternatively, the video-level recommendations 206 are provided as well.

In the shown example, the tags 102, 103 and the recommendations 206, 208 are already in the databases 202, 209, as they were e.g. generated in an offline mode of the device. That is, the tags 102, 103 and the recommendations 206, 208 can be generated in advance, before they are actually needed by the user device 203. However, the tags 102, 103 and the recommendations 206, 208 can also be generated in an online mode, that is, right when they are needed by the user device 203, which is currently playing the video stream 101.

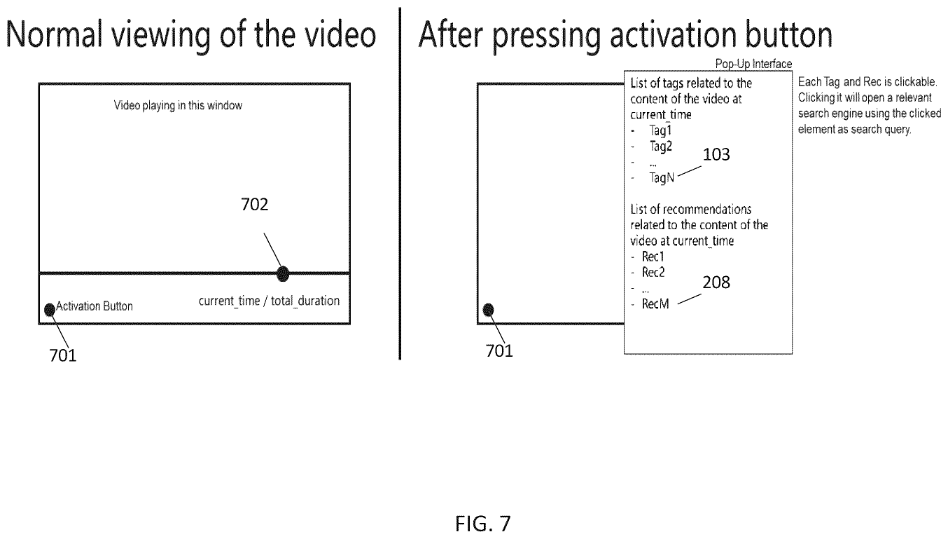

FIG. 7 shows an exemplary user interface which can be employed by the user device 101 for displaying the tags 102, 103 and the recommendations 206, 208 while playing the video stream 101. In the left hand part of the figure, a video screen is shown which plays the video stream 101. The screen comprises an activation button 701 and means 702 for indicating the current time and a total duration of the video stream 101. The activation button 701 can be used to generate the user input 204, which then comprises the playback time information 205 corresponding to the means 702 indicating the current time of the video stream 101. In other words, the activation button 701 can be regarded an interface trigger that a user can activate to make use of the device 100. It will send a request for the tags 102, 103 and the recommended content 206, 208 to the server (i.e., the device 100) by sending necessary information (such as a form of video ID and a current time of viewing). The interface will then display the tags 102, 103 and content 206, 208 sent by the server and show an interface that the user can interact with.

Once the user input 204 is received by the device 100 and the tags 102, 103 and the recommendations 206, 208 are provided to the user device 203, an interface pops up which e.g., lists the tags 103 and the recommendations 208 related to the content of the video at the current time (i.e., the playback time information 205). The tags and recommendations are clickable and may open, based on the tag or recommendation, e.g. a search engine for starting a search or a web browser.

As it was already described in view of the above figures, in particular in FIG. 3 and FIG. 6, the device 100 can operate in an offline mode, and/or in an online mode.

As e.g. shown in FIG. 3, in the offline mode the server (i.e. the device 100) repeatedly fetches popular videos (i.e. the video stream 101) from the web, performs an analysis with the inference module to extract tags 102, 103, and then uses those tags 102, 103 to retrieve the recommended content 206, 208 for the video stream 101. The tags 102, 103 are then stored in the tag database 202 and the recommended content 206, 208 in the recommendation database 209. The server keeps repeating this process so that all of the necessary information is precomputed for when a user request it.

As e.g. shown in FIG. 6, in the offline mode, on the user side the user presses the activation button 701, the video ID (e.g. the URL) and the timestamp of the current viewing of the video will be sent to the server. The server will check if the video has been already processed and if so, it will fetch the tags and recommended content (compatible to the current timestamp) and send them to the user to show in the interface. If the video hasn't been already processed, an error message can be sent to the user, or an online mode of the device 100 can be started.

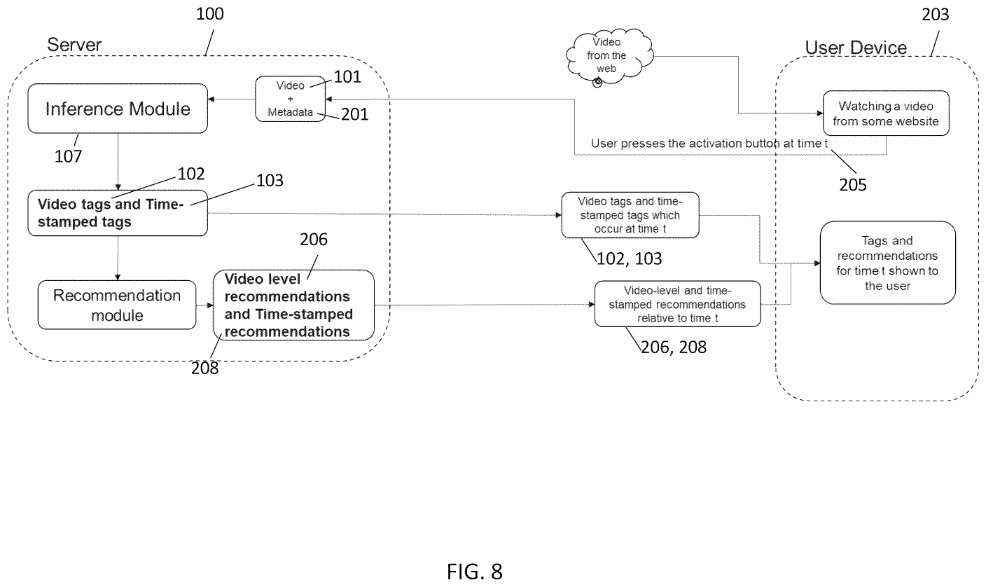

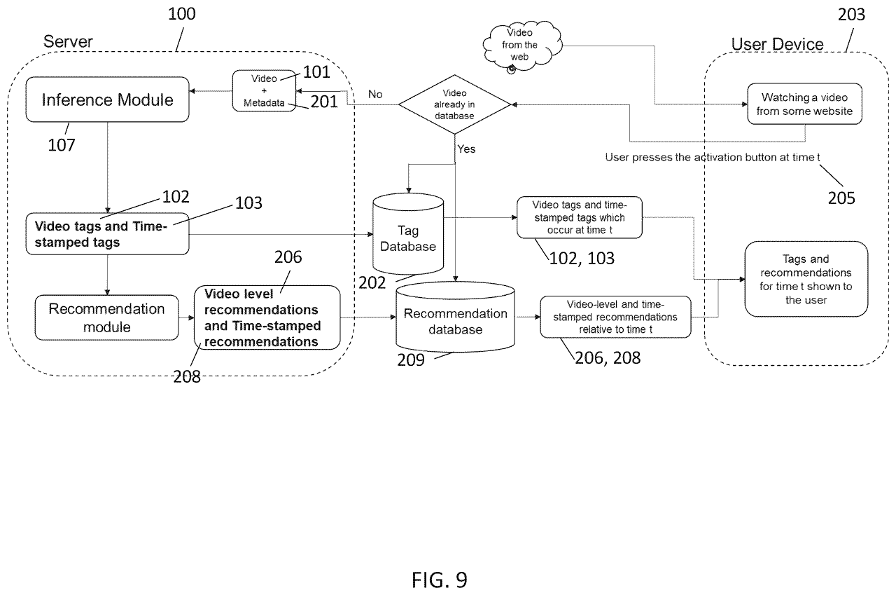

FIG. 8 and FIG. 9 illustrate the online mode, respectively a combined offline and online mode of the device 100.

As shown in FIG. 8, the server (i.e. the device 100) only acts when the user requests it (e.g. when a request 210 is received from a user device 203). Similar to the offline mode, while a user is watching a video, he will press the activation button 701 and send a video ID and timestamp of the current viewing to the server. Differently from before, these won't be checked in a database but the tags and recommendations will be computed on the fly with the same process as in the offline version.

The online and the offline mode can also be combined, as shown in FIG. 9. As in the offline mode, the server repeatedly processes video streams 101, storing the outputs in the databases 202, 209. Differently from that, if a user requests a video stream 101 that hasn't been already processed, it will not throw an error but it will compute the tags 102, 103 and recommendations 206, 208 on the fly. The results will be sent to the user device 203 directly (like in the online version) but will also be stored in the databases 202, 209 for future requests for the same video 101.

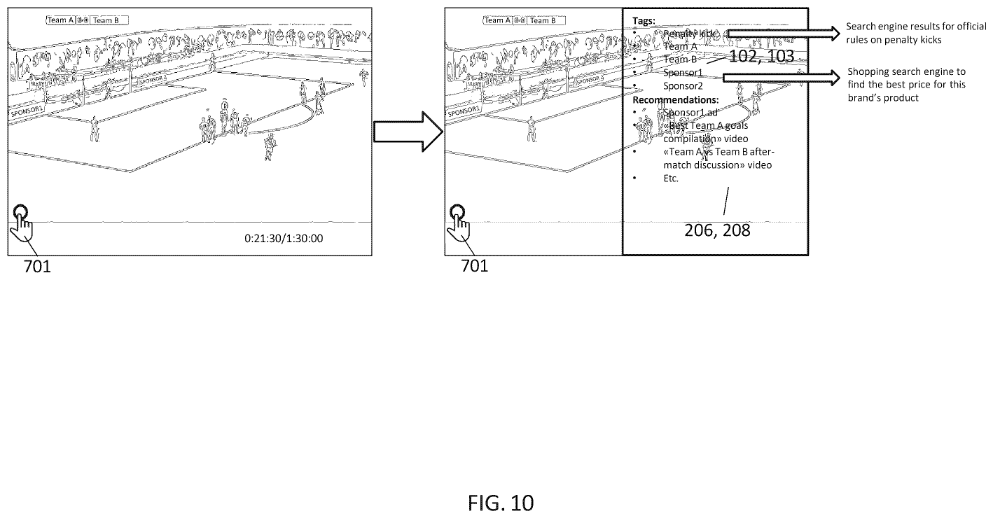

FIG. 9 and FIG. 10 show a variation of the user interface for the user device 203 by illustrating an example of a possible interaction of a user with the user device 203 and the device 100.

While watching the video stream 101, a user can press an activation button 701 (left side). A pop-up interface may appear (right side) showing time-stamped tags 103 and time-stamped recommendations 208. The tags 103 are related to the recently viewed content of the video stream 101 (e.g. since a penalty kick is being shown, the “penalty kick” tag will appear.) Other tags 103 may include many different types of recent content, such as logos appearing on the screen or what is being talked about by the commentary in the video audio. Recommendations 208 are also related to the recent content.

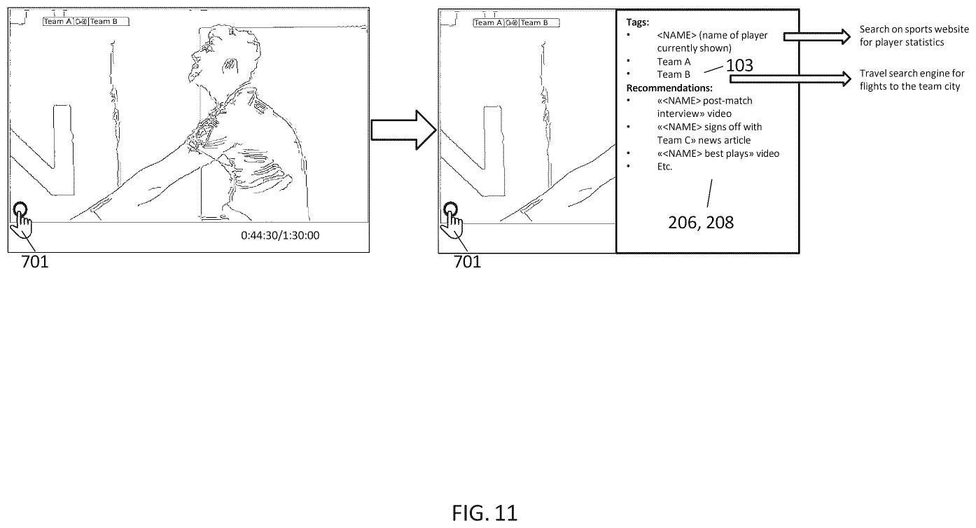

Based on the moment the activation button 701 is pressed, the tags 103 and recommendations 208 will change as shown in FIG. 11, giving the user the control to choose what the tags 103 should focus on. Now that the video stream 101 is not focusing on a soccer action but on a player close-up, the tags 103 will show the name of the player and the recommended content will change to reflect that. Additionally, by clicking the tags 103 the user can show search results on an external search engine, making navigation faster and easier. The search engine can be chosen by the user or suggested by the interface (e.g. clicking on the name of a town can suggest to open it with the map app or a traveling search engine).

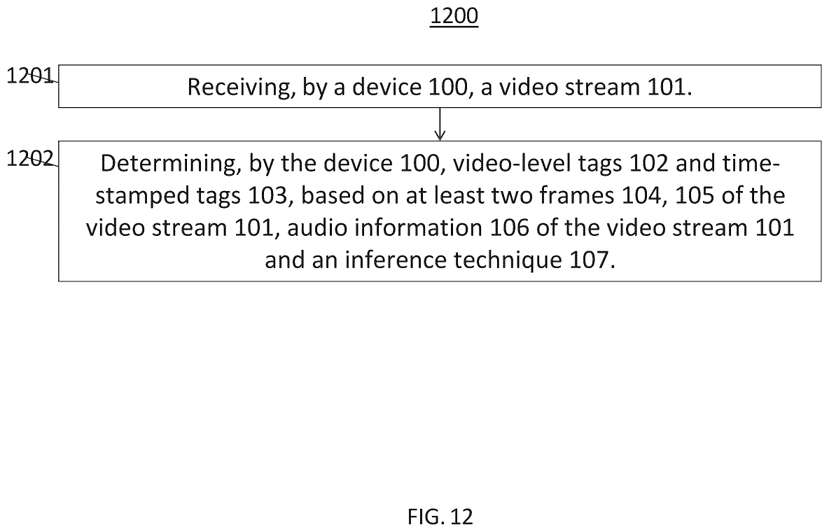

FIG. 12 shows a schematic view of a method 1200. The method 1200 is for multimodal video analysis. The method 1200 comprises a first step of receiving 1201, by a device 100, a video stream 101. The method 1200 comprises a second step of determining 1202, by the device 100, video-level tags 102 and time-stamped tags 103, based on at least two frames 104, 105 of the video stream 101, audio information 106 of the video stream 101 and an inference technique 107.

The present disclosure has been described in conjunction with various embodiments as examples as well as implementations. However, other variations can be understood and effected by those persons skilled in the art and practicing the claimed disclosure, from the studies of the drawings, this disclosure, and the independent claims. In the claims as well as in the description, the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A device comprising:
an inference circuit configured to:
receive a video stream comprising at least two frames and metadata; and
determine video-level tags and time-stamped tags based on the at least two frames and metadata, audio information of the video stream, and an inference technique; and
a tag database configured to store the video-level tags and the time-stamped tags.

2. (canceled)

3. The device of claim 1, wherein the inference technique comprises at least one of automatic speech recognition (ASR), optical character recognition (OCR), computer vision (CV), or natural language processing (NLP).

4. (canceled)

5. The device of claim 1, wherein the device is configured to provide the video-level tags to a user device playing the video stream.

6. The device of claim 1, wherein the device is configured to:
receive a user input comprising playback time information from a user device playing the video stream; and
provide the time-stamped tags to the user device based on the playback time information.

7. The device of claim 6, further comprising a resource index, and wherein the device is configured to:
determine video-level recommendations based on the video-level tags and the resource index; and/or
determine time-stamped recommendations based on the time-stamped tags and the resource index.

8. The device of claim 7, further comprising a recommendation database configured to store the video-level recommendations and the time-stamped recommendations.

9. The device of claim 7, wherein the device is configured to provide the video-level recommendations to a user device playing the video stream.

10. The device of claim 7, wherein the device is configured to provide, in response to the user input, the time-stamped recommendations to the user device based on the playback time information.

11. The device of claim 1, wherein the device is configured to;
receive a request from a user device playing the video stream;
receive the video stream;
determine the video-level tags and the time-stamped tags; and
directly provide, in response to the request, the video-level tags and the time-stamped tags to the user device.

12. The device of claim 1, wherein the video-level tags comprise information that refers to the video stream as a whole.

13. The device of claim 1, wherein the time-stamped tags comprise information that refers to a specific time range of the video stream.

14. A method for multimodal video analysis and comprising:
receiving a video stream comprising at least two video frames and metadata;
determining video-level tags and time-stamped tags based on the at least two video frames and metadata, audio information of the video stream, and an inference technique; and
storing the video-level tags and the time-stamped tags in a tag database.

15. The method of claim 14, wherein the inference technique comprises at least one of automatic speech recognition (ASR), optical character recognition (OCR), computer vision (CV), or natural language processing (NLP).

16. (canceled)

17. The method of claim 14, further comprising providing the video-level tags to a user device playing the video stream.

18. The method of claim 14, further comprising:
receiving a user input comprising playback time information from a user device playing the video stream, and
providing the time-stamped tags to the user device based on the playback time information.

19. The method of claim 14, further comprising:
determining video-level recommendations based on the video-level tags and a stored resource index; and/or
determining time-stamped recommendations based on the time-stamped tags and the stored resource index.

20. The method of claim 19, further comprising storing the video-level recommendations and the time-stamped recommendations in a recommendation database.

21. A computer program product comprising instructions that are stored on a non-transitory medium and that, when executed by one or more processors, cause a device to:
receive a video stream comprising at least two frames and metadata;
determine video-level tags and time-stamped tags based on the at least two frames and metadata, audio information of the video stream, and an inference technique; and
store the video-level tags and the time-stamped tags in a tag database.

22. The computer program product of claim 21, wherein the instructions further cause the device to provide the video-level tags to a user device playing the video stream.

23. The computer program product of claim 21, wherein the instructions further cause the device to:
receive a user input comprising playback time information from a user device playing the video stream; and
provide the time-stamped tags to the user device based on the playback time information.
